(19) United States
(12) Patent Application Publication
(10) Pub. No.: US 2025/0217316 A1
(43) Pub. Date: Jul. 3, 2025

(54) ATTRIBUTE INFORMATION ACQUISITION METHOD AND APPARATUS FOR DIRECTORY OF DISTRIBUTED FILE SYSTEM,AND DEVICE

(71) Applicants: Beijing Baidu Netcom Science Technology Co., Ltd., Beijing (CN); Baidu Online Network Technology (Beijing) Co., Ltd., Beijing (CN)

(72) Inventors: Biao CAO, Beijing (CN); Jielong JIAN, Beijing (CN); Qiushi CHEN, Beijing (CN); Liguo DUAN, Beijing (CN); Ran ZHENG, Beijing (CN)

(21) Appl. No.: 19/083,686

(22) Filed: Mar. 19, 2025

(30) Foreign Application Priority Data
Dec. 20, 2024 (CN) 202411899848.2

(51) Int. Cl. G06F 16/13; G06F 16/172; G06F 16/182

(52) U.S. Cl. CPC G06F 16/13; G06F 16/172; G06F 16/182

(57) ABSTRACT

The present disclosure provides an acquisition method and apparatus for attribute information of a directory of a distributed file system, and a device, and relates to the field of computer technologies and, in particular, to the field of big data and a distributed file system. The specific implementation is as follows: when an acquisition instruction is acquired, judging whether a log index of a directory indicated by the acquisition instruction is less than a transaction index of the directory, and whether a queue index of the directory is greater than or equal to the transaction index; if both of the above conditions are met, reading attribute modification information of a directory from a memory queue; and determining the attribute information of the current directory according to the attribute modification information and an attribute file of the directory.

### CROSS-REFERENCE TO RELATED APPLICATION

This application claims priority to Chinese Patent Application No. 202411899848.2, filed on Dec. 20, 2024, which is hereby incorporated by reference in its entirety.

### TECHNICAL FIELD

The present disclosure relates to big data and a distributed file system in computer technologies and, in particular, to an attribute information acquisition method and apparatus for a directory of a distributed file system, and a device.

### BACKGROUND

With the wide application of a distributed file system, more and more users store data in the distributed file system, realizing online sharing of data. There may be a large number of concurrent operations for shared data. The concurrent operations may include a request for processing the data, a request for acquiring attribute information of the data and the like.

Therefore, there is an urgent need for a method to acquire attribute information quickly and accurately.

### SUMMARY

The present disclosure provides an attribute information acquisition method and apparatus for a directory of a distributed file system, and a device.

According to a first aspect of the present disclosure, there is provided an attribute information acquisition method for a directory of a distributed file system, including:
in response to an acquisition instruction, if determining that a log index of the directory indicated by the acquisition instruction is less than a transaction index of the directory, determining a queue index in a memory queue corresponding to the directory; where the acquisition instruction indicates to acquire attribute information of the directory; and
when the queue index is greater than or equal to the transaction index, reading attribute modification information of the directory from the memory queue; and determining the attribute information of the directory according to the attribute modification information and an attribute file of the directory;
where the log index indicates update times for updating the directory, and the transaction index indicates operation times for an operation on the directory; and the memory queue stores the attribute modification information of the directory, and the queue index indicates operation times of the memory queue.

According to a second aspect of the present disclosure, there is provided an attribute information acquisition apparatus for a directory of a distributed file system, including:
a first judging unit, configured to: in response to an acquisition instruction, if determining that a log index of the directory indicated by the acquisition instruction is less than a transaction index of the directory, determine a queue index in a memory queue corresponding to the directory; where the acquisition instruction indicates to acquire attribute information of the directory; and
a second judging unit, configured to read attribute modification information of the directory from the memory queue when the queue index is greater than or equal to the transaction index; and determine the attribute information of the directory according to the attribute modification information and an attribute file of the directory;
where the log index indicates update times for updating the directory, and the transaction index indicates operation times for an operation on the directory; and the memory queue stores the attribute modification information of the directory, and the queue index indicates operation times of the memory queue.

According to a third aspect of the present disclosure, there is provided an electronic device, including:
at least one processor; and a memory connected with the at least one processor in a communication way; where, the memory stores instructions executable by the at least one processor, and the instructions are executed by the at least one processor to enable the at least one processor to perform the method according to the first aspect.

According to a fourth aspect of the present disclosure, there is provided a non-transitory computer-readable storage medium storing computer instructions, where the computer instructions are configured to cause a computer to perform the method according to the first aspect.

According to a fifth aspect of the present disclosure, there is provided a computer program product, including a computer program stored in a readable storage medium from which at least one processor of an electronic device may read the computer program, and the at least one processor executes the computer program to cause the electronic device to perform the method described in the first aspect.

It should be understood that the content described in this section is not intended to identify key or important features of embodiments of the present disclosure, nor is it intended to limit the scope of the present disclosure. Other features of the present disclosure will be readily understood from the following description.

### BRIEF DESCRIPTION OF DRAWINGS

The drawings are for a better understanding of solutions, but do not limit the present disclosure. In the drawings:

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic block diagram of an electronic device for implementing embodiments of the present disclosure;

FIG. 7 is a scene diagram of a distributed file system that may implement embodiments of the present disclosure.

### DETAILED DESCRIPTION

Exemplary embodiments of the present disclosure are described below in combination with the drawings, in which various details of embodiments of the present disclosure are included to facilitate understanding, and they shall be considered as exemplary only. Therefore, those skilled in the art should realize that various changes and modifications may be made to the embodiments described herein without departing from the scope and spirit of the present disclosure. Similarly, for the sake of clarity and conciseness, the description of well-known functions and structures is omitted in the following.

With the wide application of a distributed file system, more and more users store data in the distributed file system, realizing online sharing of data. In order to improve an operation efficiency when the user accesses the distributed file system and improve a path resolution speed, at present, index units have been introduced into the distributed file system to speed up the path resolution speed.

However, with the addition of the index unit, operations such as creating a directory and deleting a directory have changed from only updating the metadata unit to updating the metadata unit and the index unit at the same time. This operation becomes a two-phase commit (2PC) transaction across units. Therefore, the complexity of its operation increases. The execution of the 2PC transaction makes the modification of the attribute file of the directory in the metadata unit increase the possibility of transaction conflict. For example, when multiple concurrent operations try to operate subdirectories of a parent directory under the same parent directory, it is necessary to frequently access an attribute file of the parent directory. In this case, the update of the attribute file of the parent directory may lead to a large number of distributed transaction conflicts. In order to avoid these transaction conflicts, operations must be queued and executed serially. However, serial execution greatly limits the processing capacity of the distributed file system, resulting in a few hundred queries-per-second (QPS) for operations in the same directory, which has the problem of low throughput.

Therefore, the present application proposes an attribute information acquisition method for a directory of a distributed file system. This method may improve the operation performance in the same directory and reduce transaction conflicts by writing the modification information of attributes into the memory queue. The improvement of this performance will further improve the response efficiency of the user' operation requests. Furthermore, according to the user's attribute query request, the attribute information may be acquired quickly and accurately.

The present disclosure provides an acquisition method and apparatus for attribute information of a directory of a distributed file system, and a device, which are applied to big data and a distributed file system in computer technologies, so as to achieve an effect of fast and accurately acquiring attribute information of the directory in the distributed file system.

It should be noted that data in this embodiment is not targeted at a specific user and cannot reflect personal information of a specific user. It should be noted that data in this embodiment comes from public data sets.

In technical solutions of the present disclosure, the collection, storage, use, processing, transmission, provision and disclosure of the user' personal information all comply with the provisions of relevant laws and regulations, and do not violate public order and good custom.

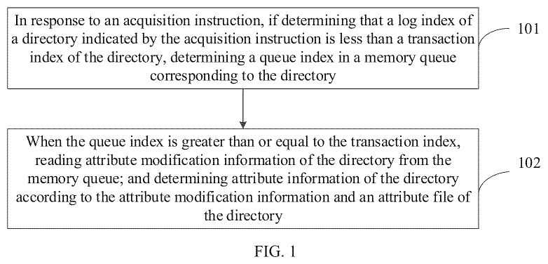

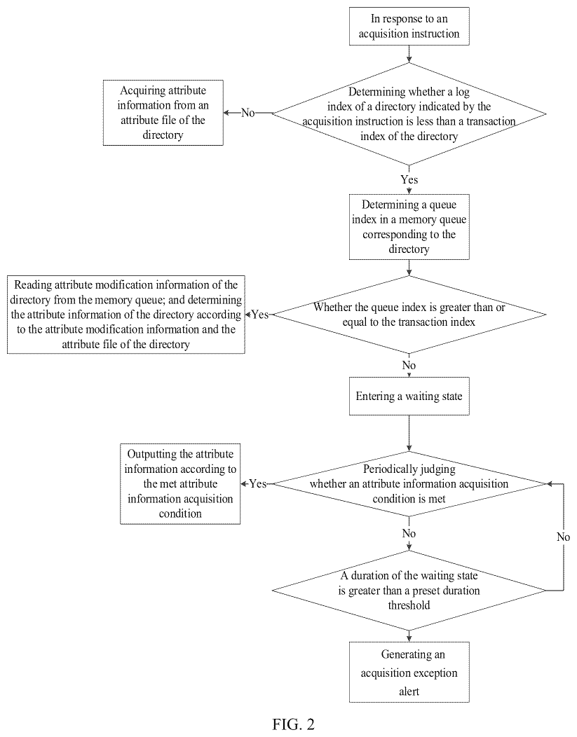

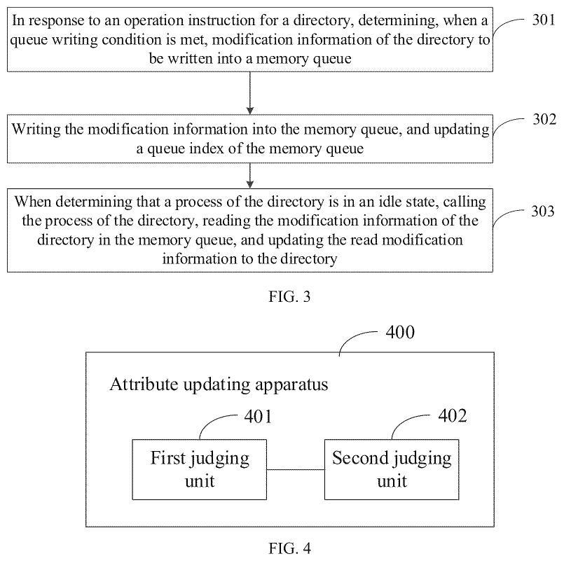

In order to make readers understand the implementation principle of the present disclosure more deeply, the embodiment shown in FIG. 1 is further refined in combination with the following FIG. 2 and FIG. 3.

FIG. 1 is a schematic diagram according to a first embodiment of the present disclosure. As shown in FIG. 1, the present disclosure provides an attribute updating method for a directory of a distributed file system, and the method includes:
101, in response to an acquisition instruction, if determining that a log index of the directory indicated by the acquisition instruction is less than a transaction index of the directory, determining a queue index in a memory queue corresponding to the directory, where the acquisition instruction indicates to acquire attribute information of the directory; the log index indicates update times for updating the directory, and the transaction index indicates operation times for an operation on the directory; and the memory queue stores the attribute modification information of the directory, and the queue index indicates operation times of the memory queue.

In this embodiment, after acquiring the acquisition instruction to query the attribute information of the directory in the distributed file system, a query operation of the attribute information of the directory may be executed on a device node in the distributed file system in response to the acquisition instruction. In order to avoid transaction conflicts when the distributed file system processes concurrent operations on subdirectories under a directory, a memory queue is set in the device node for writing update information on the attribute of the directory. Therefore, during reading the attribute information of this directory, it is necessary to judge the reading position. Where the reading manner include reading directly from the attribute file of the directory, and reading from both the attribute file and the memory queue. In the manner of reading from both the attribute file and the memory queue, if the attribute information requested by the user is a non-numeric attribute, a latest non-numeric attribute may be acquired directly from the memory queue. If the attribute information requested by the user is a numeric attribute, since the modification information of the attribute is recorded in the queue, it is necessary to modify it based on an attribute value in the attribute file and by using the modification information in the memory queue to obtain the final attribute value.

When the user requests to obtain the attribute information of the directory, the log index and the transaction index of the directory may be acquired first.

The log index of the directory indicates update times for updating the directory. In an implementation, the log index indicates the number of operations on the log file that have been updated to the directory. In an implementation, the log index may be the largest log entry that has been applied. In the distributed file system, the log entry that has been applied is an entry of the log that has been executed and written. That is, the number of operations that have been finished after the commitment of the 2PC transaction.

The transaction index indicates operation times for operations on the directory. The operations on the directory may specifically be operations on the subdirectories of the directory. In an implementation, the transaction index may be the largest log entry that has been committed. Compared with the log index, there may be a log of operations that have been committed but not yet applied in the transaction index. For example, the log of the operations that has been committed but not yet applied may be: an operation has finished the update on the index unit and realized the transaction commitment, but has not finished the update of the directory on a metadata unit, so the operation has not finished the commitment of 2PC and has not been applied.

By comparing the log index of the directory with the transaction index of the directory, it may be determined whether the operations on the directory have finished the corresponding update of the directory.

If the log index is greater than or equal to the transaction index, it indicates that all operations on the directory have been committed. That is, all operations on the directory have finished the update of the directory. Therefore, the attribute information may be acquired directly from the attribute file of the directory.

Otherwise, if the log index is less than the transaction index, it means that only some operations on the directory have been committed. That is, there are still some operations for the directory that have not finished the update of the directory. In the present disclosure, the modification information that has not finished updating the directory is written in the memory queue. Therefore, in the case that log index is less than the transaction index, the queue index of the memory queue corresponding to the directory may be acquired. In an implementation, the memory queue may store the attribute modification information of the directory. In an implementation. The queue index indicates operation times of the memory queue.

In an implementation, the queue index may be acquired by acquiring an index of modification information of a queue tail of the memory queue corresponding to the directory. Since a writing order of the memory queue is queue tail writing, the index of the queue tail is the queue index indicating the operation times of the memory queue. This manner may realize the fast acquisition of the queue index and improve the efficiency of acquiring the queue index.

102, when the queue index is greater than or equal to the transaction index, reading attribute modification information of the directory from the memory queue; and determining the attribute information of the directory according to the attribute modification information and an attribute file of the directory.

In this embodiment, since there is a possibility that the process of the directory has read the modification information from the queue, but the process is still processing the modification information and has not updated the attribute file of the directory, after acquiring the queue index, it is necessary to further compare the queue index of the directory with the transaction index of the directory. If the queue index is greater than or equal to the transaction index, it means that there is no situation that the modification information is stuck in the process. At this time, the modification information may be directly read from the queue, and the read modification information may be combined with the information in the attribute file of the directory to obtain the final attribute information of the directory. Otherwise, if the queue index is less than the transaction index, it means that there is a situation that the modification information is stuck in the process. At this time, it is necessary to enter a waiting state, waiting for the modification information in the process to be written into the attribute file of the directory.

In an implementation, when the queue index is greater than or equal to the transaction index, the attribute information of the directory needs to be determined according to the attribute modification information and the attribute file of the directory, and the specific process may include:
1021, merging the attribute modification information to obtain summary information.

In this embodiment, since the modification information is usually written in case of high concurrency, the number of the modification information is usually multiple. Therefore, after acquiring the modification information of the directory, the modification information may be merged to obtain the summary information. When the summary information is used to modify the attributes of the directory, the modification efficiency may be improved.

1022, merging the summary information with the attribute information in the attribute file of the directory to obtain the final attribute information of the directory.

In this embodiment, the attribute information may be acquired from the attribute file of the directory. Furthermore, the summary information may be used to update the attribute information to obtain the final attribute information. The attribute information is the final attribute information of the directory.

The acquisition of the attribute information of the directory is realized through the above steps 1021 and 1022, which realizes the fast reading and writing of the attributes of the directory on the basis of avoiding transaction conflicts in the operations on the directory, and improves the user experience.

In this embodiment, the attribute information of the directory is read by comparing the log index, the transaction index and the queue index of the directory. Further, it realizes the accurate and fast reading of the attribute information under the condition that there is a conflict between operations on the directory, which improves the reading efficiency and accuracy of the attribute information and improves the user experience.

FIG. 2 is a schematic diagram according to a second embodiment of the present disclosure. As shown in FIG. 2, the present disclosure provides an attribute updating method for a directory of a distributed file system, and the method includes:
201, in response to an acquisition instruction, if determining that a log index of the directory indicated by the acquisition instruction is less than a transaction index of the directory, determining a queue index in a memory queue corresponding to the directory, where the acquisition instruction indicates to acquire attribute information of the directory.

In this embodiment, the execution of step 201 is similar to that of the above step 101, and it is not repeated here.

202, if determining that the log index of the directory indicated by the acquisition instruction is greater than or equal to the transaction index of the directory, acquiring the attribute information from an attribute file of the directory.

In this embodiment, if it is determined that the log index of the directory indicated by the acquisition instruction is greater than or equal to the transaction index of the directory, it means that all operations on the directory have been applied. That is, all the operations on the directory have finished the update of the directory. At this time, the attribute information may be directly acquired from the attribute file of the directory. By comparing the log index with the transaction index, the judgment of the latest attribute information stored in the attribute file of the directory is realized, and when information in the attribute file is determined to be the latest attribute information, the acquisition of the attribute information is realized directly from the attribute file, which further improves the accurate and fast reading of attribute information, improves the reading efficiency and the reading accuracy of attribute information, and improves the user experience.

203, when the queue index is greater than or equal to the transaction index, reading attribute modification information of the directory from the memory queue; and determining the attribute information of the directory according to the attribute modification information and the attribute file of the directory.

In this embodiment, the execution of step 203 is similar to that of the above step 102, and it is not repeated here.

204, when the queue index is less than the transaction index, entering a waiting state, where the waiting state represents that modification information in the memory queue has been read by the process, but not written into the attribute file.

In this embodiment, when the queue index is greater than or equal to the transaction index, it means that there is a case that the modification information has been read by the process but not updated to the attribute file of the directory. In order to avoid a problem of inaccuracy of the attribute information read by the user caused by this case, it may be realized by further comparing the queue index and the transaction index. When the queue index is less than the transaction index, it means that there is a case that the modification information has been read by the process and not written into the attribute file. At this time, since the modification information that has been read by the process cannot be directly processed, it is necessary to wait for the process to complete the processing of the modification information. That is, the waiting state is entered.

205, in the waiting state, periodically judging whether an attribute information acquisition condition is met, where the attribute information acquisition condition represents a condition for exiting the waiting state and realizing acquisition of the attribute information of the directory.

In this embodiment, in the waiting state, it may be periodically judged whether the attribute information acquisition condition is met. If the attribute information acquisition condition is met, the waiting state may be exited and the acquisition of the attribute information of the directory may be realized. Otherwise, if the attribute information acquisition condition is not met, it is necessary to continue waiting for the attribute information acquisition condition to be reached in the waiting state. In an implementation, the period may be determined according to the reading and writing efficiency of the process.

In an implementation, the attribute information acquisition condition represents a condition that may realize the acquisition of the attribute information of the directory. In an implementation, the attribute information acquisition condition of the directory may include the conditions shown in step 202 and step 203. That is, the log index of the directory is greater than or equal to the transaction index of the directory, or the log index of the directory is less than the transaction index of the directory, and the queue index of the directory is greater than or equal to the transaction index of the directory.

In an implementation, when the log index of the directory is greater than or equal to the transaction index of the directory, it means that the modification information of all operations on the directory has been written into the attribute file of the directory correspondingly, and the update of the attribute of the directory is finished. In an implementation, when the log index of the directory is less than the transaction index of the directory and the queue index of the directory is greater than or equal to the transaction index of the directory, it means that the written of the modification information in the process has been finished, but the modification information of the directory still exists in the memory queue.

206, if the attribute information acquisition condition is met, outputting the attribute information according to the met attribute information acquisition condition.

In this embodiment, if the attribute information acquisition condition is met, the attribute information acquisition method may be determined according to the met attribute information acquisition condition. Different attribute information acquisition conditions may correspond to different attribute information acquisition methods.

In an implementation, if the log index of the directory is greater than or equal to the transaction index of the directory, the attribute information is acquired from the attribute file of the directory. If the log index of the directory is greater than or equal to the transaction index of the directory, it means that in the memory queue, all the modification information of the directory has been updated to the attribute file of the directory. Therefore, the attribute information may be acquired directly from the attribute file of the directory.

In an implementation, if the log index of the directory is less than the transaction index of the directory and the queue index of the directory is greater than or equal to the transaction index of the directory, the attribute information is acquired from the memory queue of the directory and the attribute file of the directory. If the log index of the directory is less than the transaction index of the directory, and the queue index of the directory is greater than or equal to the transaction index of the directory, it means that the modification information in the process has been updated to the attribute file of the directory. However, after the process reads the modification information of the directory from the memory queue, the modification information of the directory is written in the memory queue again. At this time, it is necessary to read the attribute information of the directory from both the memory queue and the attribute file of the directory.

By setting the exit condition of the above waiting state, the acquisition of the attribute information of the directory may be further ensured in the waiting state, thereby further improving the reading efficiency and reading accuracy of the attribute information and improving the user experience.

By setting the waiting state in the above steps 204-206, the problem that the attribute information of the directory acquired by the user is inaccurate after the modification information is read by the process may be avoided, and the reading efficiency and reading accuracy of the attribute information are further improved, and the user experience is improved.

207, if a duration of the waiting state is greater than a preset duration threshold, generating an acquisition exception alert, where the acquisition exception alert represents a failure of acquiring the attribute information of the directory indicated by the acquisition instruction.

In this embodiment, after entering the waiting state, it may also be timed to determine the duration of the waiting state. If the duration is greater than the preset duration threshold, the acquisition request may be ended, and the acquisition exception alert may be generated and returned to the user. The acquisition exception alert is used to inform the user of the failure of reading of the attribute information of the directory. By recording the duration of the waiting state, and returning a failure alert when the duration of the waiting state is greater than the preset duration threshold, the problem of poor user experience caused by the long-term lack of feedback of the user's acquisition request may be avoided.

On the basis of the first embodiment shown in FIG. 1 and the second embodiment shown in FIG. 2, when the attribute information of the directory is written in an ATTR file of the directory, an implementation of the attribute information of the directory may include the following steps. When the attribute information of the directory is read, it is necessary to confirm whether the attribute ATTR of the directory is a latest written value. If the committed value that meets the latest modification is read, it means that an isolation level of read commitment is realized.

In the distributed file system configured based on Raft, Raft log is always serial and ordered. The mechanism thereof is similar to that of redo log. Therefore, the present application may use the Raft log to ensure that the read operation can meet the isolation level of the read commitment. At present, two indexes are provided in Raft: a last_committed_index and a known_applied_index. Where the last_committed_index is configured to record the largest log entry that has been committed, but may not be applied yet. The known_applied_index is configured to record the largest log entry that has been applied, indicating that execution and writing have been finished in the distributed transaction database.

When requesting to read the attribute ATTR of the directory, the judgement whether the attribute ATTR is the latest written value can be achieved by checking the relationship between the last_committed_index and the known_applied_index corresponding to the ATTR. The known_applied_index corresponding to the ATTR may be recorded as the log index of the directory, and the last_committed_index may be recorded as the transaction index of the directory.

If the log index is greater than or equal to the transaction index, it means that the latest change of the ATTR has been committed and applied, therefore, the attribute may be safely read from the ATTR. If the log index is less than the transaction index, the memory queue needs to be involved. The corresponding maximum index at the queue tail that needs to obtain memory is used as the queue index. If the queue index is greater than or equal to the transaction index, it means that the change of ATTR has not been fully applied, but the memory queue contains new data. Therefore, by reading the latest data from this queue, the attributes of this directory may be acquired. In an implementation, for some numerical data, after reading the latest modification information in the memory queue, the data is also need to be acquired from the ATTR, and the final attribute information is acquired based on the combination of the data and the modification information. If the queue index is less than the transaction index, it means that the change of ATTR has not been applied, and the memory queue does not contain new data. At this time, it is necessary to wait until the log index of ATTR is greater than or equal to the transaction index, or the queue index exceeds the transaction index. If none of these conditions are not met within the set duration threshold, the request for acquiring the attribute information is fail.

FIG. 3 is a schematic diagram according to a third embodiment of the present disclosure. As shown in FIG. 3, the present disclosure provides an attribute updating method for a directory of a distributed file system, and the method includes:
301, in response to an operation instruction for the directory, determining, when a queue writing condition is met, modification information of the directory to be written into the memory queue; where the operation instruction indicates to operate the directory; the queue writing condition indicates a condition that the modification information needs to be generated according to the operation instruction of the directory and written into the memory queue; and the modification information indicates modification of the attribute information of the directory.

In this embodiment, when the operation instruction for the directory is acquired, it may be judged whether the queue writing condition is met. The queue writing condition indicates a condition that modification information needs to be generated according to the operation instruction of the directory and written into the queue. That is, when the operation instruction meets the queue writing condition, the modification information of the directory to be written in the memory queue may be generated according to the operation instruction. Otherwise, if the operation instruction meets the queue writing condition, the update of the attributes of the directory under this operation may be executed by using a conventional method. In an implementation, it updates the attribute of the directory under the operation by using the conventional method, that is, updates the attribute file of the directory directly according to the operation.

In an implementation, the queue writing condition may include that there is a conflict in the read-write event of the operation file of the directory. Or, the queue writing condition may include that the number of concurrent operations in subdirectories under the directory is greater than a number threshold. In view of the above two cases, when the queue writing condition is met, it means that the number of operations on the directory is large, and there are many conflicts when updating the attributes of the directory according to the conventional method. Therefore, in order to avoid conflicts generated in the process of updating the attributes of the directory, the modification information may be generated according to the operation instruction and written into the queue.

302, writing the modification information into the memory queue, and updating a queue index of the memory queue.

In this embodiment, after the modification information generated according to the operation instruction is obtained, the modification information may be written into the memory queue. When being written into the memory queue, the written of the modification information may be realized according to a time sequence. After the modification information is written into the memory queue, since an index of the queue tail of the memory queue changes, the queue index may be updated correspondingly.

Through the execution of the above steps 301 and 302, the judgment whether the operation information needs to be written into the memory queue is realized, the flexibility of use of the memory queue is improved, the modification information corresponding to the operation instruction is written into the memory queue when there is high concurrency for the directory, the transaction conflict caused by directly modifying the attributes of the directory is avoided, and the throughput capacity of the distributed file system is improved.

303, when determining that a process of the directory is in an idle state, calling the process of the directory, reading the modification information of the directory in the memory queue, and updating the read modification information to the directory.

In this embodiment, each directory may correspond to a process. When the process of the directory is in an idle state, if the process detects that data is written in the queue corresponding to the directory, the process may read the modification information of the directory in the memory queue. After the process reads the modification information, it may merge the modification information to obtain summary information, and then use the summary information to update the attribute information of the directory. The idle process reads the modification information in the memory queue and updates it to the directory, asynchronous writing of data in the memory queue is realized, which avoids the transaction conflict caused by directly modifying the attributes of the directory during the operation execution, and improves the throughput capacity of the distributed file system.

In an implementation, the process of updating the attribute information of the directory by the process may include the following.

3031, setting a read-write lock on the attribute file of the directory.

In this embodiment, firstly, after requesting the attribute file of the directory, the process may set the read-write lock on the attribute file of the directory. The setting of the read-write lock may avoid the conflict when the process reads and writes the attribute information in the attribute file.

3032, reading the attribute information of the directory from the attribute file of the directory.

In this embodiment, the process may read the attribute information from the attribute file of the directory. The attribute information is unmodified attribute information.

3033, modifying the attribute information according to the modification information to obtain the modified attribute information.

In this embodiment, the attribute information read in step 3032 may be modified. The modification process may be executed according to the summary information of the modification information. For example, when the summary information includes modification information of a numeric attribute in the attribute information, the modification information may be superimposed in the numeric attribute. For another example, when the summary information includes modification information of a non-numerical attribute in the attribute information, the numerical attribute may be replaced with the modification information.

3034, writing the modified attribute information into the attribute file of the directory.

In this embodiment, the modified attribute information may be rewritten into the attribute file to realize asynchronous modification of the attributes of the directory.

3035, unlocking the read-write lock of the attribute file of the directory.

In this embodiment, after the writing of the attribute information is finished, the read-write lock on the attribute file of the directory may be released, so that other processes may continue to read the attribute file of the directory.

In this embodiment, through the execution of the above steps 3031-3035, asynchronous update of the attribute file is realized, and update information may be written through the asynchronous update, which ensures the data consistency between the metadata unit and the index unit in the distributed file system and improves the throughput capacity of the distributed file system.

On the basis of the third embodiment shown in FIG. 3, when the attribute information of the directory is written in an ATTR file of the directory, taking an mkdir operation as an example, the process of realizing asynchronous update of the ATTR through the memory queue may include the following steps. The execution of the following steps realizes the separation of the ATTR from the participants in the 2PC transaction. The 2PC transaction initiated by the mkdir may first create a directory. When the 2PC transaction initiated by the mkdir is committed, the modification information of the ATTR of the directory may be written into the memory queue. Based on the memory queue, the modification information of the ATTR may be fetched from the queue in batches, and after the modification information is merged, it may be written into the ATTR asynchronously to realize the update of the ATTR.

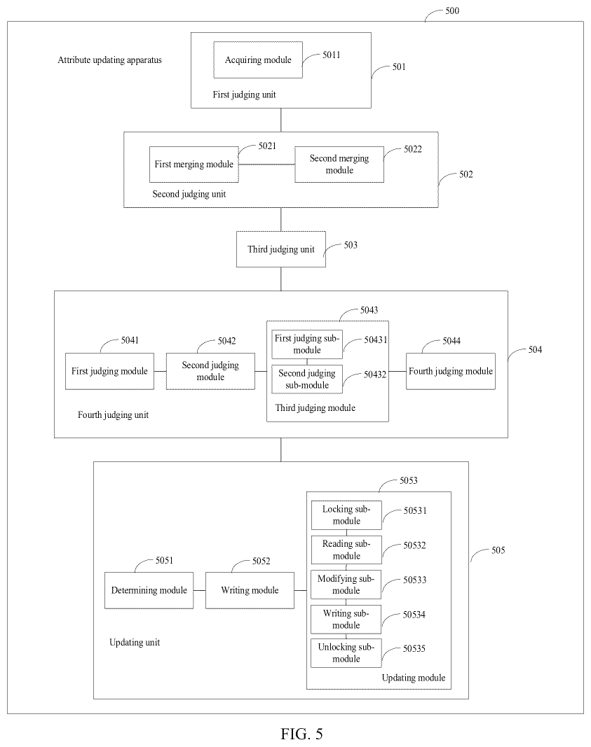

FIG. 4 is a schematic diagram according to a fourth embodiment of the present disclosure. As shown in FIG. 4, the present disclosure provides an attribute updating apparatus 400 for a directory of a distributed file system, and the apparatus includes:
a first judging unit 401, configured to: in response to an acquisition instruction, if determining that a log index of the directory indicated by the acquisition instruction is less than a transaction index of the directory, determine a queue index in a memory queue corresponding to the directory, where the acquisition instruction indicates to acquire attribute information of the directory; and
a second judging unit 402, configured to read attribute modification information of the directory from the memory queue when the queue index is greater than or equal to the transaction index; and determine the attribute information of the directory according to the attribute modification information and an attribute file of the directory.

The log index indicates update times for updating the directory, and the transaction index indicates operation times for an operation on the directory. The memory queue stores the attribute modification information of the directory, and the queue index indicates operation times of the memory queue.

The apparatus in this embodiment may implement the technical solutions in the above methods, and their specific implementation processes and technical principles are the same, which are not repeated here.

FIG. 5 is a schematic diagram according to a fifth embodiment of the present disclosure. As shown in FIG. 5, the present disclosure provides an attribute updating apparatus 500 for a directory of a distributed file system, and the apparatus includes:
a first judging unit 501, configured to: in response to an acquisition instruction, if determining that a log index of the directory indicated by the acquisition instruction is less than a transaction index of the directory, determine a queue index in a memory queue corresponding to the directory, where the acquisition instruction indicates to acquire attribute information of the directory; and
a second judging unit 502, configured to read attribute modification information of the directory from the memory queue when the queue index is greater than or equal to the transaction index; and determine the attribute information of the directory according to the attribute modification information and an attribute file of the directory.

The log index indicates update times for updating the directory, and the transaction index indicates operation times for an operation on the directory. The memory queue stores the attribute modification information of the directory, and the queue index indicates operation times of the memory queue.

In an implementation, the first judging unit 501 includes:
an acquiring module 5011, configured to acquire an index of the modification information of a queue tail of the memory queue corresponding to the directory, and take the index as the queue index.

In an implementation, the second judging unit 502 includes:
a first merging module 5021, configured to merge the attribute modification information to obtain summary information; and
a second merging module 5022, configured to merge the summary information with the attribute information in the attribute file of the directory to obtain a final attribute information of the directory.

In an implementation, the attribute updating apparatus 500 further includes:
a third judging unit 503, configured to acquire the attribute information from the attribute file of the directory if determining that the log index of the directory indicated by the acquisition instruction is greater than or equal to the transaction index of the directory.

In an implementation, the attribute updating apparatus 500 further includes a fourth judging unit 504; and the fourth judging unit 504 includes:
a first judging module 5041, configured to enter a waiting state when the queue index is less than the transaction index, where the waiting state represents that the modification information in the memory queue has been read by the process, but not written into the attribute file;
a second judging module 5042, configured to periodically judge whether an attribute information acquisition condition is met in the waiting state, where the attribute information acquisition condition represents a condition for exiting the waiting state and realizing acquisition of the attribute information of the directory;
a third judging module 5043, configured to output, if the attribute information acquisition condition is met, the attribute information according to a met attribute information acquisition condition.

In an implementation, the third judging module 5043 includes:
a first judging sub-module 50431, configured to obtain the attribute information from the attribute file of the directory if the log index of the directory is greater than or equal to the transaction index of the directory; and
a second judging sub-module 50432, configured to obtain attribute information from the memory queue of the directory and the attribute file of the directory if the log index of the directory is less than the transaction index of the directory and the queue index of the directory is greater than or equal to the transaction index of the directory.

In an implementation, the fourth judging unit 504 further includes:
a fourth judging module 5044, configured to generate an acquisition exception alert if a duration of the waiting state is greater than a preset duration threshold, where the acquisition exception alert represents a failure of acquiring the attribute information of the directory indicated by the acquisition instruction.

In an implementation, the attribute updating apparatus 500 further includes an updating unit 505, including:
a determining module 5051, configured to, in response to the operation instruction for the directory, determine the modification information of the directory to be written into the memory queue when the queue writing condition is met, where the operation instruction indicates to operate the directory; the queue writing condition indicates a condition that the modification information needs to be generated according to the operation instruction of the directory and written into the memory queue; and the modification information indicates modification of the attribute information of the directory; and
a writing module 5052, configured to write the modification information into the memory queue and update the queue index of the memory queue.

In an implementation, the updating unit 505 further includes:
an updating module 5053, configured to retrieve the process of the directory, read the modification information of the directory in the memory queue, and update the read attribute modification to the directory when determining that the process of the directory is in an idle state.

In an implementation, the updating module 5053 includes:
a locking sub-module 50531, configured to set a read-write lock on the attribute file of the directory;
a reading sub-module 50532, configured to read the attribute information of the directory from the attribute file of the directory;
a modifying sub-module 50533, configured to modify the attribute information according to the modification information to obtain the modified attribute information;
a writing sub-module 50534, configured to write the modified attribute information into the attribute file of the directory; and
an unlocking sub-module 5053, configured to unlock the read-write lock of the attribute file of the directory.

The apparatus in this embodiment may implement the technical solutions in the above methods, and their specific implementation processes and technical principles are the same, which are not repeated here.

According to embodiments of the present disclosure, the present disclosure also provides an electronic device, a readable storage medium and a computer program product.

According to the embodiments of the present disclosure, the present disclosure also provides a computer program product, which includes a computer program stored in a readable storage medium, at least one processor of an electronic device may read the computer program from the readable storage medium, and the at least one processor executes the computer program to enable the electronic device to execute the solutions provided in any of the above embodiments.

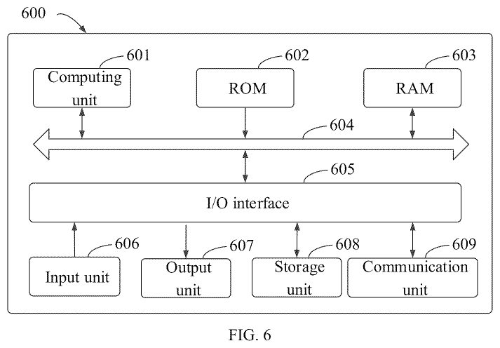

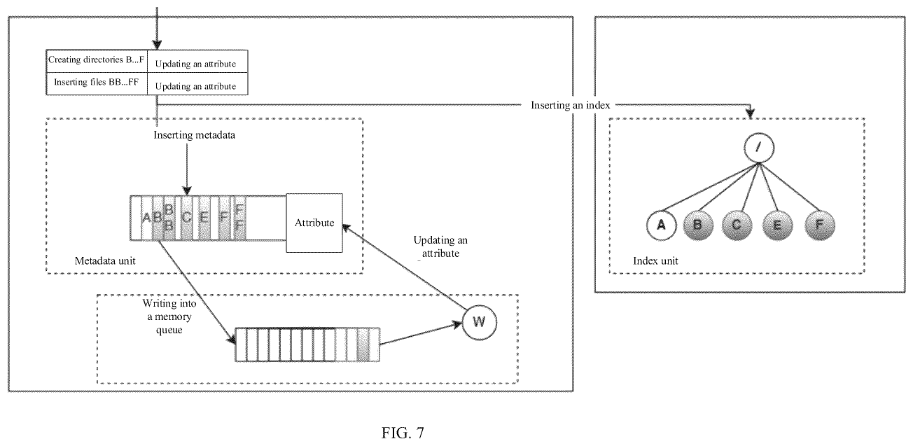

FIG. 6 shows a schematic block diagram of an example electronic device 600 that may be configured to implement the embodiments of the present disclosure. The electronic device is intended to represent various forms of digital computers, such as a laptop computer, a desktop computer, a workstation, a personal digital assistant, a server, a blade server, a large-scale computer, and other suitable computers. The electronic devices may also represent various forms of mobile apparatuses, such as a personal digital assistant, a cellular phone, a smart phone, a wearable device and other similar computing devices. The components shown herein, their connections and relationships, and their functions are only examples, and are not intended to limit the implementation of the present disclosure described and/or claimed herein.

As shown in FIG. 6, the device 600 includes a computing unit 601, which may execute various appropriate actions and processes according to a computer program stored in a read only memory (ROM) 602 or a computer program loaded from a storage unit 608 into a random access memory (RAM) 603. Various programs and data required for the operation of the device 600 may also be stored in the RAM 603. The computing unit 601, the ROM 602 and the RAM 603 are connected to each other through a bus 604. An input/output (I/O) interface 605 is also connected to the bus 604.

A plurality of components in the device 600 are connected to the I/O interface 605, including: an input unit 606, for example, a keyboard, a mouse and the like; an output unit 607, for example, various types of displays, speakers and the like; a storage unit 608, for example, a magnetic disk, an optical disk and the like; and a communication unit 609, for example, a network card, a modem, a wireless communication transceiver and the like. The communication unit 609 allows the device 600 to exchange information/data with other devices through a computer network such as the Internet and/or various telecommunication networks.

The computing unit 601 may be various general and/or special processing components with processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller and the like. The computing unit 601 performs various methods and processes described above, for example, the attribute information acquisition method for a directory of a distributed file system. For example, in some embodiments, the attribute information acquisition method for a directory of a distributed file system may be implemented as a computer software program, which is tangibly included in a machine readable medium, for example, the storage unit 608. In some embodiments, part or all of the computer program may be loaded and/or installed in the device 600 via the ROM 602 and/or the communication unit 609. When the computer program is loaded into the RAM 603 and executed by the computing unit 601, one or more steps of the attribute information acquisition method for a directory of a distributed file system described above may be executed. Alternatively, in other embodiments, the computing unit 601 may be configured to execute the attribute information acquisition method for a directory of a distributed file system by any other suitable means (for example, by means of firmware).

FIG. 7 is a scene diagram of a distributed file system that may implement embodiments of the present disclosure. As shown in FIG. 7, the distributed file system may acquire an external operation request. The operation request may create directories B, F and the like, and may also insert files BB, FF and the like. Each operation request may correspond to an attribute update. Based on the operation request, metadata may be inserted into a fragment of a metadata unit. The metadata may be a directory or a file included in the operation request. The operation request may also write modification information of an attribute file of a parent directory in the metadata unit into a memory queue. Through a process W, the modification information may be acquired from the memory queue, and the update of the attribute of the parent directory may be finished. And index information may be inserted into an index unit based on the operation request.

Various implementations of the systems and technologies described above herein may be implemented in digital electronic circuitry, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or combinations thereof. These various implementations may include being implemented in one or more computer programs, where the one or more computer programs may be executed and/or interpreted in a programmable system including at least one programmable processor, and the programmable processor may be a special- purpose or general-purpose programmable processor and may receive data and instructions from a storage system, at least one input apparatus, and at least one output apparatus, and transmit the data and the instructions to the storage system, the at least one input apparatus, and the at least one output apparatus.

The program codes for implementing the methods of the present disclosure may be written in any combination of one or more programming languages. These program codes may be provided to a processor or controller of a general-purpose computer, a special-purpose computer or other programmable data processing apparatus, so that the program codes, when executed by the processor or the controller, cause functions/operations specified in flowcharts and/or block diagrams to be implemented. The program codes may be completely executed in a machine, partially executed in the machine, as a separate software package, partially executed in the machine and partially executed in a remote machine or completely executed in the remote machine or a server.

In the context of the present disclosure, the machine readable medium may be a tangible medium that may contain or store a program for use by or in connection with an instruction execution system, apparatus or device. The machine readable medium may be a machine readable signal medium or a machine readable storage medium. A machine readable medium may include, but is not limited to, an electronic, a magnetic, an optical, an electromagnetic, an infrared, or a semiconductor system, apparatus or device, or any suitable combination of the above. More specific examples of the machine readable storage medium may include an electrical connection based on one or more wires, a portable computer disk, a hard disk, a random access memory (RAM), a read only memory (ROM), an erasable programmable read only memory (EPROM or a flash memory), an optical fiber, a convenient compact disk read only memory (CD-ROM), an optical storage device, a magnetic storage device, or any suitable combination of the above.

In order to provide interaction with the user, the systems and technologies described herein may be implemented in a computer, where the computer includes: a display apparatus (for example, a CRT (cathode ray tube) or an LCD (liquid crystal display) monitor) for displaying information to the user; and a keyboard and a pointing apparatus (for example, a mouse or a trackball) through which the user may provide input to the computer. Other kinds of apparatuses may also be used to provide interaction with the user. For example, the feedback provided to the user may be any form of sensory feedback (for example, visual feedback, auditory feedback, or tactile feedback); and the input from the user may be received in any form (including acoustic input, voice input or tactile input).

The systems and technologies described herein may be implemented in a computing system (e.g., as a data server) including a back-end component, or in a computing system (e.g., an application server) including a middleware component, or in a computing system (e.g., a user computer with a graphical user interface or a web browser through which the user may interact with the implementations of the systems and technologies described herein) including a front-end component, or in a computing system including any combination of the back-end component, the middleware component or the front-end component. Components of the system may be interconnected by any form or medium of digital data communication (e.g., a communication network). Examples of the communication networks include a local area network (LAN), a wide area network (WAN) and Internet.

A computer system may include a client and a server. The client and the server are generally located far away from each other and usually interact with each other through a communication network. A relationship between the client and the server is generated by computer programs running in corresponding computers and having a client-server relationship with each other. The server may be a cloud server, also known as a cloud computing server or a cloud host, and it is a host product in the cloud computing service system, so as to solve the shortcomings of traditional physical host and VPS (“Virtual Private Server”, or “VPS” for short) service, which are being difficult for management and weak in business expansion. The server may also be a server of a distributed system or a server combined with a blockchain.

It should be understood that steps may be reordered, added or deleted using various forms of processes shown above. For example, the steps recorded in the present disclosure may be executed in parallel, sequentially or in different orders, as long as the expected results of the technical solutions disclosed in the present disclosure may be realized, which are not limited herein.

The above specific implementations do not limit the protection scope of the present disclosure. It should be understood by those skilled in the art that various modifications, combinations, sub-combinations and substitutions may be made according to design requirements and other factors. Any modification, equivalent substitution and improvement made within the spirit and principle of the present disclosure should be included in the protection scope of the present disclosure.

What is claimed is:

1. An attribute information acquisition method for a directory of a distributed file system, comprising:
in response to an acquisition instruction, in case of determining that a log index of the directory indicated by the acquisition instruction is less than a transaction index of the directory, determining a queue index in a memory queue corresponding to the directory; wherein the acquisition instruction indicates to acquire attribute information of the directory;
in a case that the queue index is greater than or equal to the transaction index, reading attribute modification information of the directory from the memory queue; and determining the attribute information of the directory according to the attribute modification information and an attribute file of the directory;
wherein the log index indicates update times for updating the directory, and the transaction index indicates operation times for an operation on the directory; and the memory queue stores the attribute modification information of the directory, and the queue index indicates operation times of the memory queue.

2. The method according to claim 1, wherein the determining the queue index in the memory queue corresponding to the directory comprises:
acquiring an index of modification information of a queue tail of the memory queue corresponding to the directory, and taking the index as the queue index.

3. The method according to claim 1, wherein the determining the attribute information of the directory according to the attribute modification information and the attribute file of the directory comprises:
merging the attribute modification information to obtain summary information;
merging the summary information with attribute information in the attribute file of the directory to obtain a final attribute information of the directory.

4. The method according to claim 1, further comprising:
in case of determining that the log index of the directory indicated by the acquisition instruction is greater than or equal to the transaction index of the directory, acquiring the attribute information from the attribute file of the directory.

5. The method according to claim 2, further comprising:
in case of determining that the log index of the directory indicated by the acquisition instruction is greater than or equal to the transaction index of the directory, acquiring the attribute information from the attribute file of the directory.

6. The method according to claim 3, further comprising:
in case of determining that the log index of the directory indicated by the acquisition instruction is greater than or equal to the transaction index of the directory, acquiring the attribute information from the attribute file of the directory.

7. The method according to claim 1, further comprising:
in a case that the queue index is less than the transaction index, entering a waiting state; wherein the waiting state represents that the modification information in the memory queue has been read by a process, but not written into the attribute file;
in the waiting state, periodically judging whether an attribute information acquisition condition is met; wherein the attribute information acquisition condition represents a condition for exiting the waiting state and realizing acquisition of the attribute information of the directory;
in a case that the attribute information acquisition condition is met, outputting the attribute information according to the met attribute information acquisition condition.

8. The method according to claim 2, further comprising:
in a case that the queue index is less than the transaction index, entering a waiting state; wherein the waiting state represents that the modification information in the memory queue has been read by a process, but not written into the attribute file;
in the waiting state, periodically judging whether an attribute information acquisition condition is met; wherein the attribute information acquisition condition represents a condition for exiting the waiting state and realizing acquisition of the attribute information of the directory;
in a case that the attribute information acquisition condition is met, outputting the attribute information according to the met attribute information acquisition condition.

9. The method according to claim 3, further comprising:
in a case that the queue index is less than the transaction index, entering a waiting state; wherein the waiting state represents that the modification information in the memory queue has been read by a process, but not written into the attribute file;
in the waiting state, periodically judging whether an attribute information acquisition condition is met; wherein the attribute information acquisition condition represents a condition for exiting the waiting state and realizing acquisition of the attribute information of the directory;
in a case that the attribute information acquisition condition is met, outputting the attribute information according to the met attribute information acquisition condition.

10. The method according to claim 4, further comprising:
in a case that the queue index is less than the transaction index, entering a waiting state; wherein the waiting state represents that the modification information in the memory queue has been read by a process, but not written into the attribute file;
in the waiting state, periodically judging whether an attribute information acquisition condition is met; wherein the attribute information acquisition condition represents a condition for exiting the waiting state and realizing acquisition of the attribute information of the directory;
in a case that the attribute information acquisition condition is met, outputting the attribute information according to the met attribute information acquisition condition.

11. The method according to claim 7, wherein in the case that the attribute information acquisition condition is met, the outputting the attribute information according to the met attribute information acquisition condition comprises:
in a case that the log index of the directory is greater than or equal to the transaction index of the directory, acquiring the attribute information from the attribute file of the directory;
in a case that the log index of the directory is less than the transaction index of the directory and the queue index of the directory is greater than or equal to the transaction index of the directory, acquiring the attribute information from the memory queue of the directory and the attribute file of the directory.

12. The method according to claim 7, wherein the method further comprises:
in a case that a duration of the waiting state is greater than a preset duration threshold, generating an acquisition exception alert, wherein the acquisition exception alert represents a failure of acquiring the attribute information of the directory indicated by the acquisition instruction.

13. The method according to claim 8, wherein the method further comprises:
in a case that a duration of the waiting state is greater than a preset duration threshold, generating an acquisition exception alert, wherein the acquisition exception alert represents a failure of acquiring the attribute information of the directory indicated by the acquisition instruction.

14. The method according to claim 1, further comprising:
in response to an operation instruction for the directory, determining, in a case that a queue writing condition is met, modification information of the directory to be written into the memory queue; wherein the operation instruction indicates to operate the directory; the queue writing condition indicates a condition that the modification information needs to be generated according to the operation instruction of the directory and written into the memory queue; and the modification information indicates modification of the attribute information of the directory;
writing the modification information into the memory queue, and updating the queue index of the memory queue.

15. The method according to claim 2, further comprising:
in response to an operation instruction for the directory, determining, in a case that a queue writing condition is met, modification information of the directory to be written into the memory queue; wherein the operation instruction indicates to operate the directory; the queue writing condition indicates a condition that the modification information needs to be generated according to the operation instruction of the directory and written into the memory queue; and the modification information indicates modification of the attribute information of the directory;
writing the modification information into the memory queue, and updating the queue index of the memory queue.

16. The method according to claim 3, further comprising:
in response to an operation instruction for the directory, determining, in a case that a queue writing condition is met, modification information of the directory to be written into the memory queue; wherein the operation instruction indicates to operate the directory; the queue writing condition indicates a condition that the modification information needs to be generated according to the operation instruction of the directory and written into the memory queue; and the modification information indicates modification of the attribute information of the directory;
writing the modification information into the memory queue, and updating the queue index of the memory queue.

17. The method according to claim 14, further comprising:
in a case that determining that a process of the directory is in an idle state, calling the process of the directory, reading modification information of the directory in the memory queue, and updating the read modification information to the directory.

18. The method according to claim 17, wherein the updating the read modification information to the directory comprises:
setting a read-write lock on the attribute file of the directory;
reading the attribute information of the directory from the attribute file of the directory;
modifying the attribute information according to the modification information to obtain modified attribute information;
writing the modified attribute information into the attribute file of the directory;
unlocking the read-write lock of the attribute file of the directory.

19. An electronic device, comprising:
at least one processor; and
a memory connected with the at least one processor in a communication way;
wherein,
the memory stores instructions executable by the at least one processor, and the instructions are executed by the at least one processor to enable the at least one processor to:
in response to an acquisition instruction, in case of determining that a log index of a directory indicated by the acquisition instruction is less than a transaction index of the directory, determine a queue index in a memory queue corresponding to the directory; wherein the acquisition instruction indicates to acquire attribute information of the directory;
in a case that the queue index is greater than or equal to the transaction index, read attribute modification information of the directory from the memory queue; and
determine the attribute information of the directory according to the attribute modification information and an attribute file of the directory;
wherein the log index indicates update times for updating the directory, and the transaction index indicates operation times for an operation on the directory; and the memory queue stores the attribute modification information of the directory, and the queue index indicates operation times of the memory queue.

20. A non-transitory computer-readable storage medium storing computer instructions, wherein the computer instructions are configured to cause a computer to perform the following operations:
in response to an acquisition instruction, in case of determining that a log index of a directory indicated by the acquisition instruction is less than a transaction index of the directory, determining a queue index in a memory queue corresponding to the directory; wherein the acquisition instruction indicates to acquire attribute information of the directory;
in a case that the queue index is greater than or equal to the transaction index, reading attribute modification information of the directory from the memory queue; and determining the attribute information of the directory according to the attribute modification information and an attribute file of the directory;
wherein the log index indicates update times for updating the directory, and the transaction index indicates operation times for an operation on the directory; and the memory queue stores the attribute modification information of the directory, and the queue index indicates operation times of the memory queue.
